(19) United States
(12) Patent Application Publication
(10) Pub. No.: US 2006/0146977 A1
(43) Pub. Date: Jul. 6, 2006

(54) Real-time multiplicity counter

(75) Inventors: Mark S. Rowland, Alamo, CA (US); Raymond A. Alvarez, Berkeley, CA (US)

Correspondence Address: Lawrence Livermore National Laboratory;Deputy Laboratory Counsel For Intellectual, Property, P.O. Box 808, L-703, Livermore, CA, 94551-0808, US

(73) Assignee: The Regents of the University of CA

(21) Appl. No.: 11/257,607

(22) Filed: Oct. 24, 2005

Related U.S. Application Data
(60) Provisional application No. 60/621,105, filed on Oct. 22, 2004.

(51) Int. Cl. G06M 11/02

(52) U.S. Cl. 377/10

(57) ABSTRACT

A neutron multi-detector array feeds pulses in parallel to individual inputs that are tied to individual bits in a digital word. Data is collected by loading a word at the individual bit level in parallel. The word is read at regular intervals, all bits simultaneously, to minimize latency. The electronics then pass the word to a number of storage locations for subsequent processing, thereby removing the front-end problem of pulse pileup.

This application claims priority to U.S. Provisional Patent Application Ser. No. 60/621,105, filed Oct. 22, 2004, titled: “Real-Time Multiplicity Counter,” incorporated herein by reference.

The United States Government has rights in this invention pursuant to Contract No. W-7405-ENG-48 between the United States Department of Energy and the University of California for the operation of Lawrence Livermore National Laboratory.

### BACKGROUND OF THE INVENTION

1. Field of the Invention

The present invention relates neutron multiplicity counting techniques, and more specifically, it relates to such a neutron multiplicity counting technique that reduces pulse pile up dead time.

2. Description of Related Art

The standard approach to neutron multiplicity counting is through the use of a “shift register” sliding word that is gated and counted repeatedly. Usually this gives data for one gate width. The shift register is a one input device where pulses can pile up and be lost

Another approach is a list mode data acquisition system. Every pulse is assigned a time fiducial and stored as a word. The volume of data that accumulates is many gigabytes if the objective is a non-destructive assay. A large quantity of data is required to minimize statistical errors.

It is desirable to provide neutron multiplicity counting utilizing multiple gates, with different definitions of the gate and counting approach, in a parallel analogy designed to reduce pulse pile up dead time. A system is desired that preprocesses neutron data into small files in real time, and reduces processing time required for gigabytes of list mode data.

### SUMMARY OF THE INVENTION

It is an object of the present invention to provide a digital data acquisition unit that collects data (e.g., neutron multiplicity data) at high rate and in real-time preprocesses large volumes of data into directly useable forms.

This and other objects will be apparent to those skilled in the art based on the disclosure herein.

Pulses from a multi-detector array are fed in parallel to individual inputs that are tied to individual bits in a digital word. Data is collected by loading a word at the individual bit level in parallel, so that there is no latency such as in a technique that uses a shift register. The word is read at regular intervals, all bits simultaneously, with no manipulation, to minimize latency. The electronics then pass the word to a number of storage locations for subsequent processing, thereby removing the front-end problem of pulse pileup. Latency is therefore limited to the latch time in the counter. The word is used simultaneously in several internal processing schemes that assemble the data in a number of more directly useable forms.

The technique is useful generally for high-speed processing of digital data, and specifically for non-destructive assaying of nuclear material and assemblies for, typically, mass and multiplication of special nuclear material (SNM).

### BRIEF DESCRIPTION OF THE DRAWINGS

The accompanying drawings, which are incorporated into and form part of this disclosure, illustrate embodiments of the invention and together with the description, serve to explain the principles of the invention.

FIG. 1 shows the neutron counting requirements matrix of the present invention.

FIG. 2 defines DAG nomenclature.

FIG. 3 illustrates the time correlation of the DAGs and the induced-fission neutrons emitted by the sample.

FIG. 4 shows examples of subgate detail.

FIG. 5 shows an example of the Mode 1A counting.

FIGS. 6, 7, 8 and 9 are examples of Mode 1B counting.

FIGS. 10 and 11 are examples of Mode 2A counting.

FIGS. 12 and 13 are examples of Mode 2B counting.

FIGS. 14 and 15 are examples of Mode 2C counting.

### DETAILED DESCRIPTION OF THE INVENTION

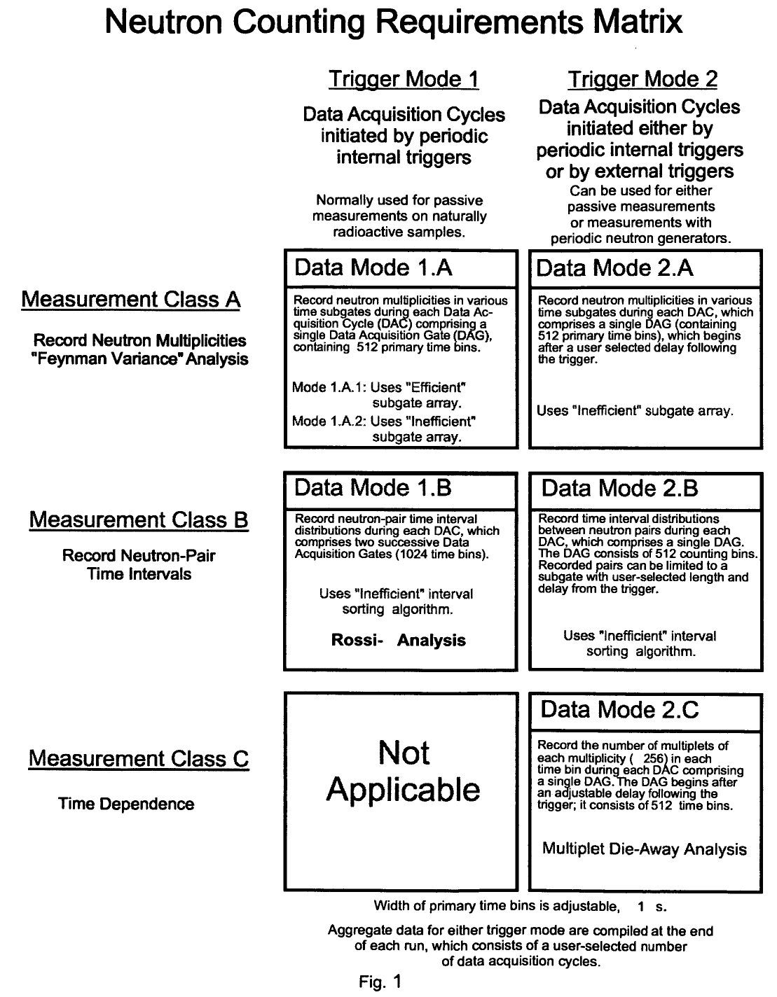

The invention is a digital data acquisition method and apparatus that collects data at high rate and in real-time preprocesses large volumes of data into directly useable forms. To explain the invention, an exemplary neutron detector system is provided for making measurements on samples that contain fissile material. As shown in the neutron counting requirements matrix of FIG. 1, the system operates in two different modes and performs several classes of measurements.

One may also describe the two modes as three modes: self triggered mode I, self triggered mode II and externally triggered mode IL Mode II counting when self-triggered is internally triggered like mode I. Mode II external trigger is typically called the neutron generator triggered counting.

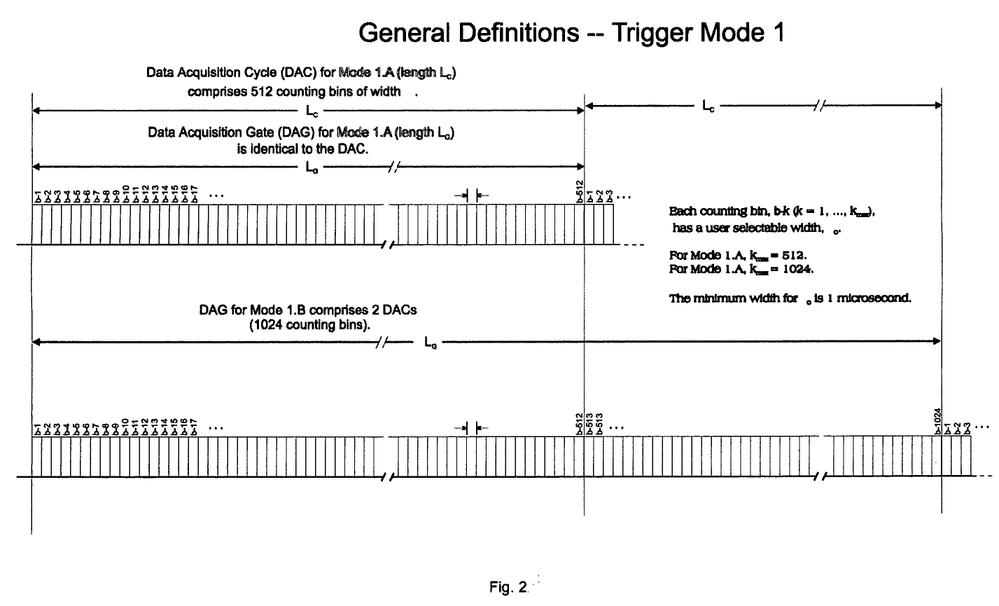

Mode I will be used for making measurements of neutrons generated by the natural radioactivity of the sample material. In this mode the detector system will employ internally generated, periodic triggers to detect neutrons in data acquisition gates (DAGs). DAG nomenclature is defined in FIG. 2. In this mode, the DAGs are uncorrelated with the neutron emission times. See FIGS. 1 and 2.

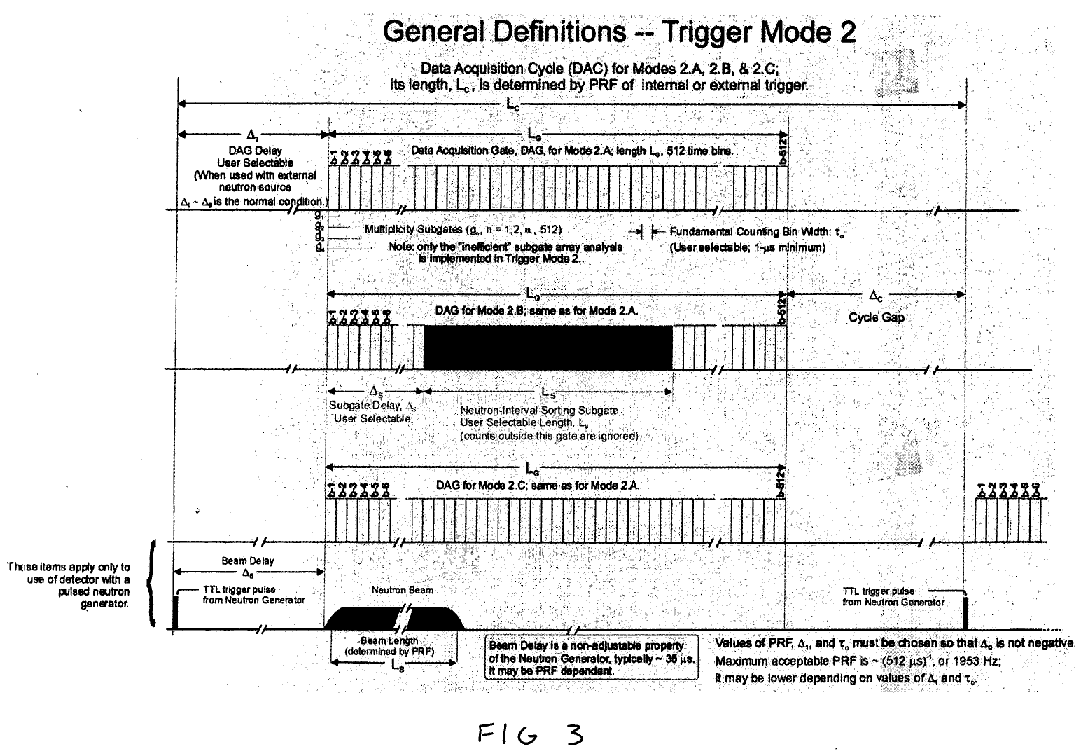

Mode II will be required for measurements on samples with very low natural neutron activity; it may also be useful for measurements on some samples with higher natural activity. Most of the neutrons detected in this mode will be generated by interactions (mainly induced fission) initiated by pulses of 14-MeV neutrons injected into the sample material by an ion-tube (D,T) neutron generator. The periodic triggers for the detector, in this mode, are provided by the neutron generator, at a fixed time relative to the 14-MeV neutron pulses. The DAGs and the induced-fission neutrons emitted by the sample are thus highly correlated in time. See FIGS. 1 and 3.

In both Mode I and Mode II, two classes of measurements (Class A and Class B) are required, and a third class (Class C) can provide valuable information in Mode II, but is not applicable to Mode I. For each class of measurement the neutrons detected within the DAGs must be sorted in different ways. In order to minimize overall data collection time, it is necessary to carry out the various classes of measurements (i.e., implement the different data sorting algorithms) simultaneously. (There may be cases, in Mode II, in which different Beam Delays are required for different measurement classes, which would require separate measurements.)

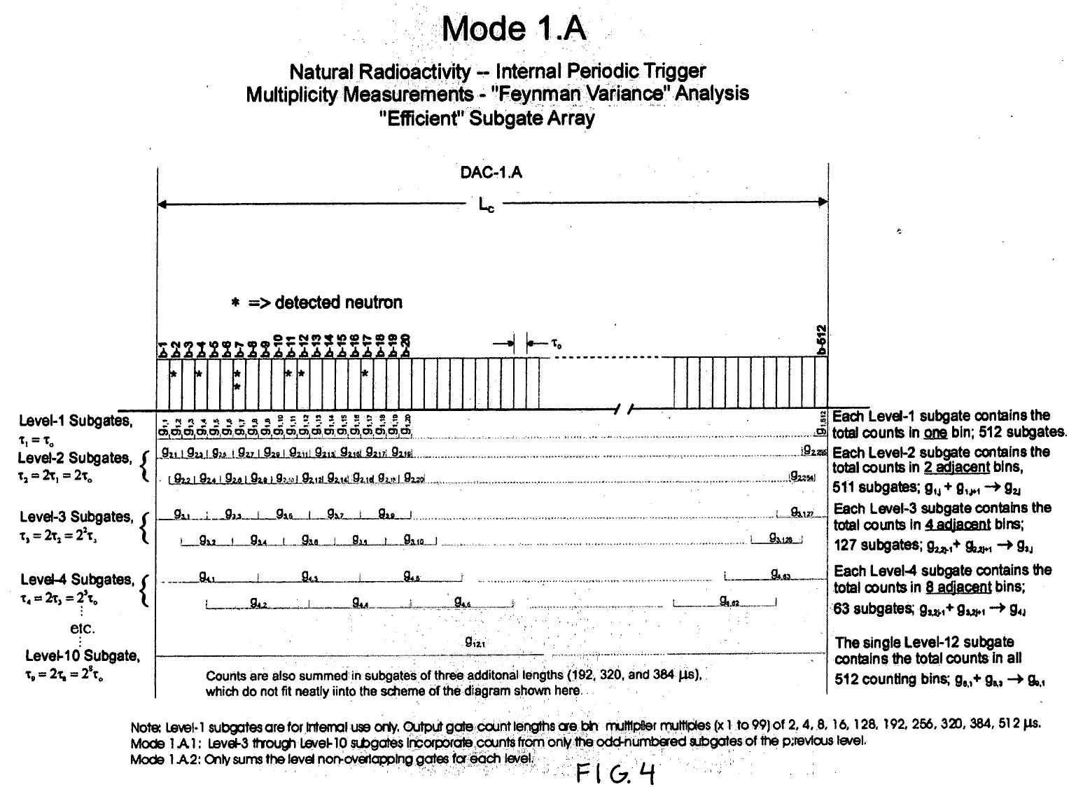

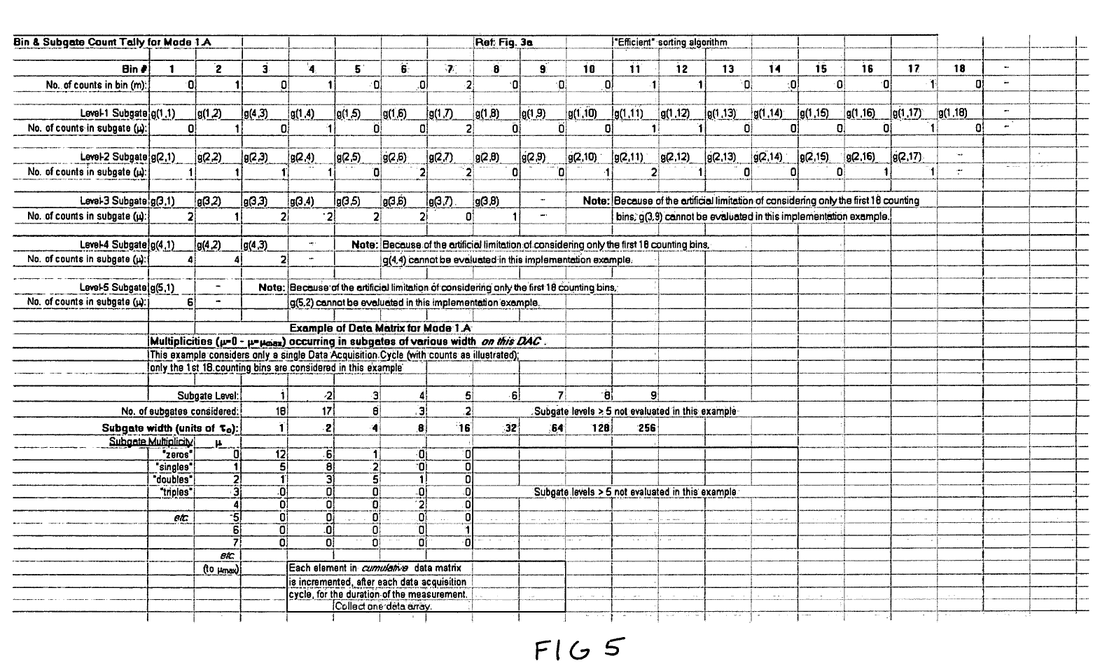

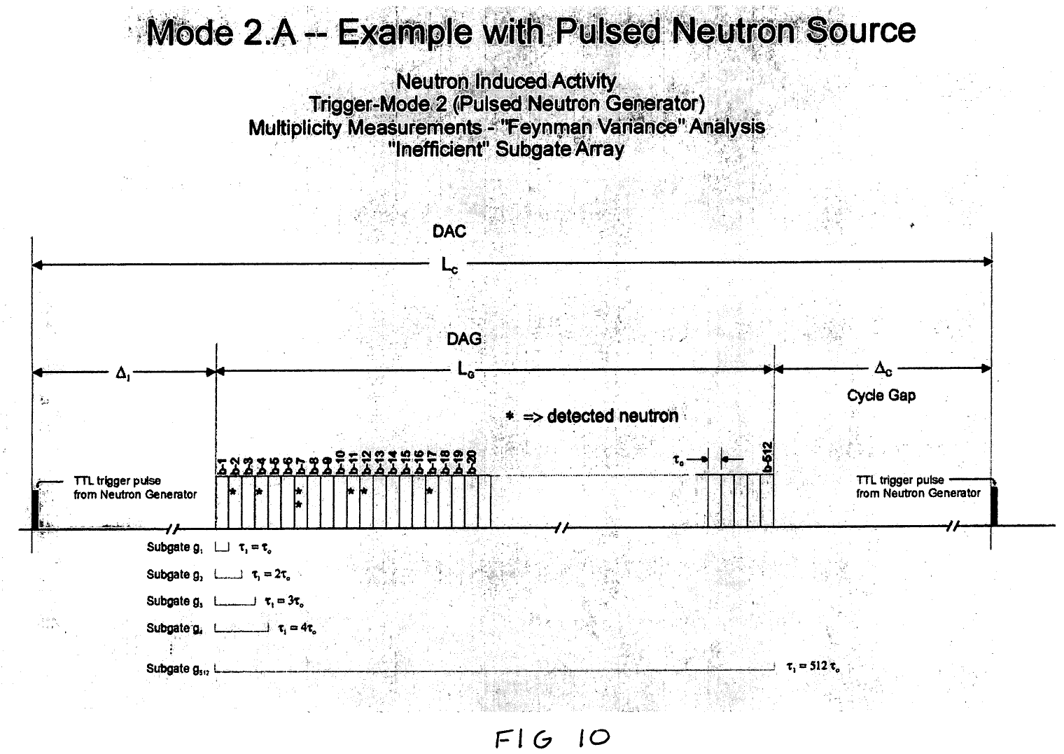

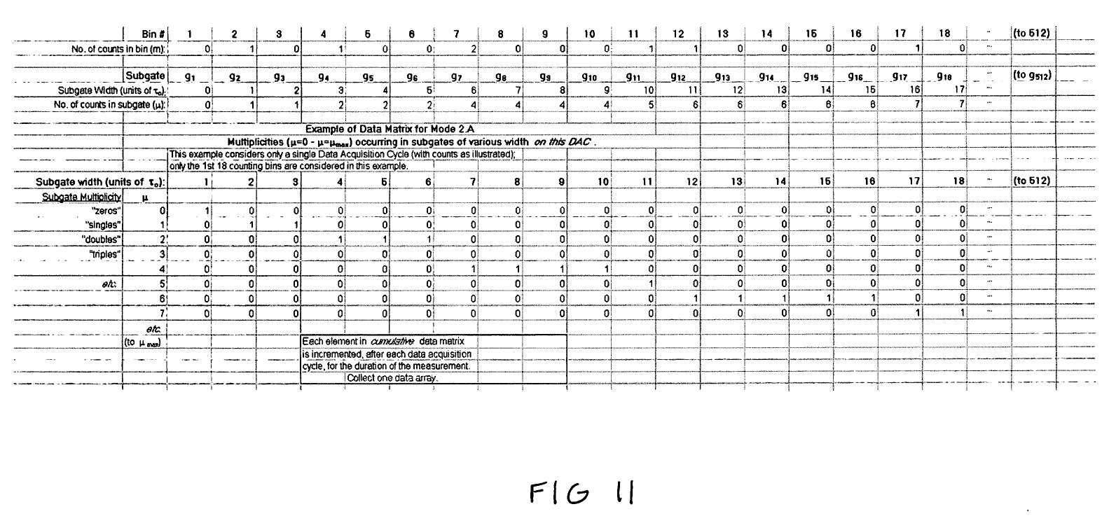

Class A: In this class of measurement data will be sorted to record statistics on neutron multiplicities detected within temporal sub-gates with different widths. A Feynman Variance type of analysis can be carried out with these data. Although the same data sorting algorithm (the “Inefficient Implementation”) can be used for both Mode I and Mode II measurements, other sorting algorithms can greatly improve data collection efficiency in Mode I. It is feasible to implement at least one of these (the “Efficient Implementation”). FIGS. 4 and 5 are an example of the Mode 1A. FIGS. 10 and 11 are examples of Mode 2A.

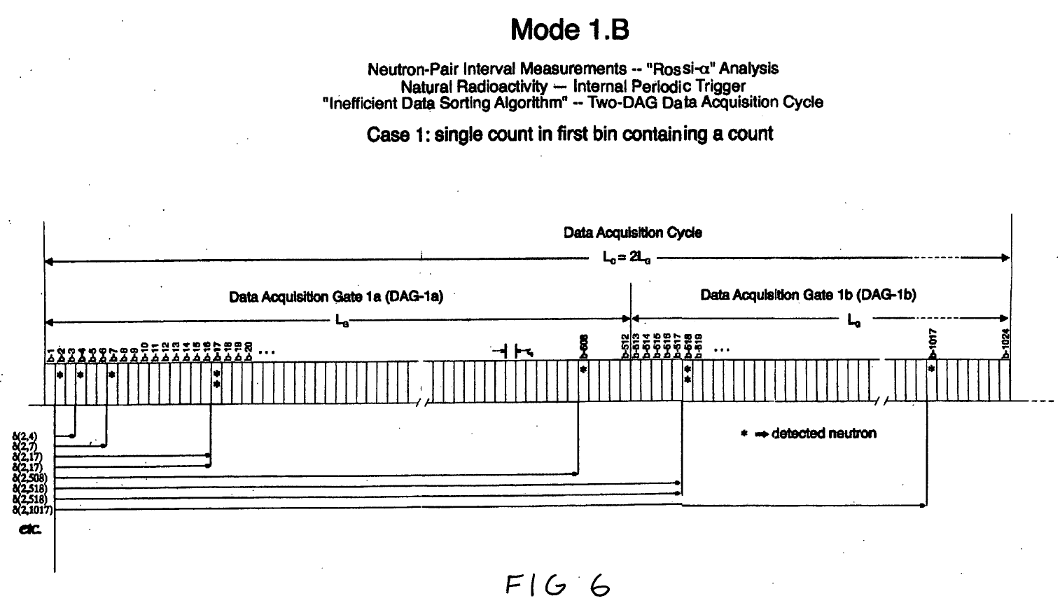

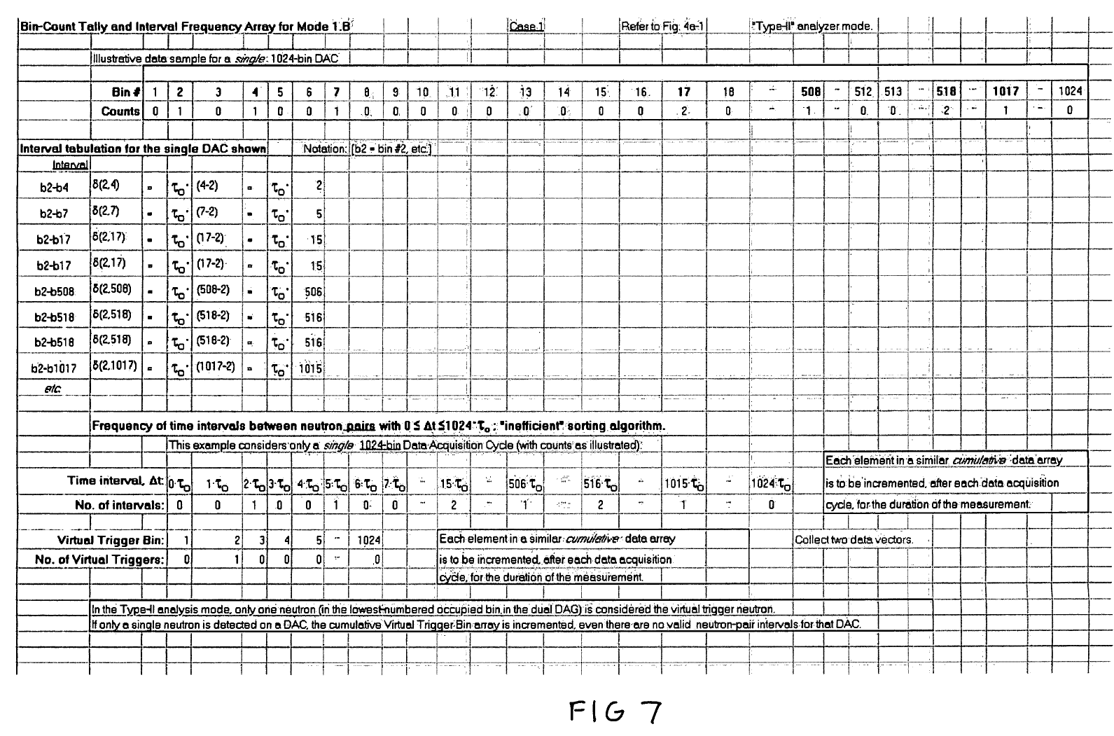

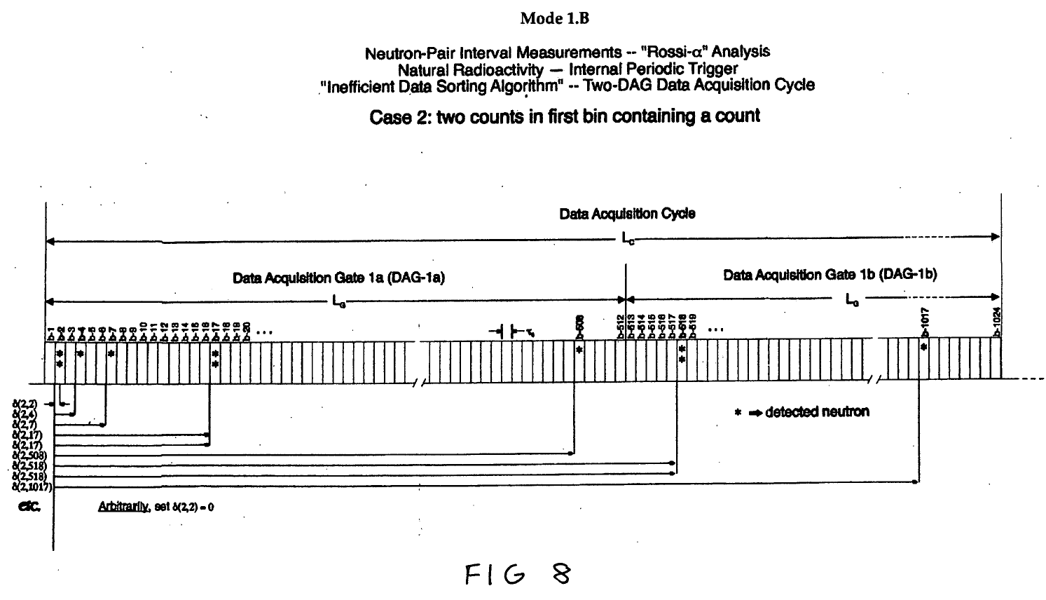

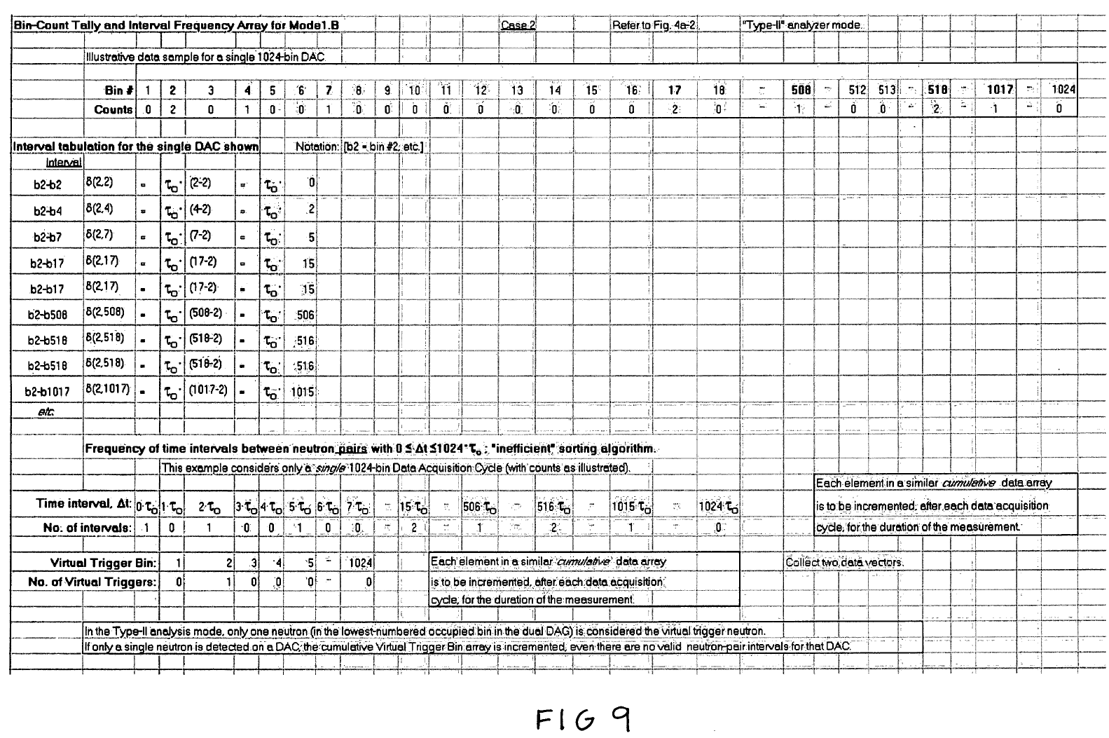

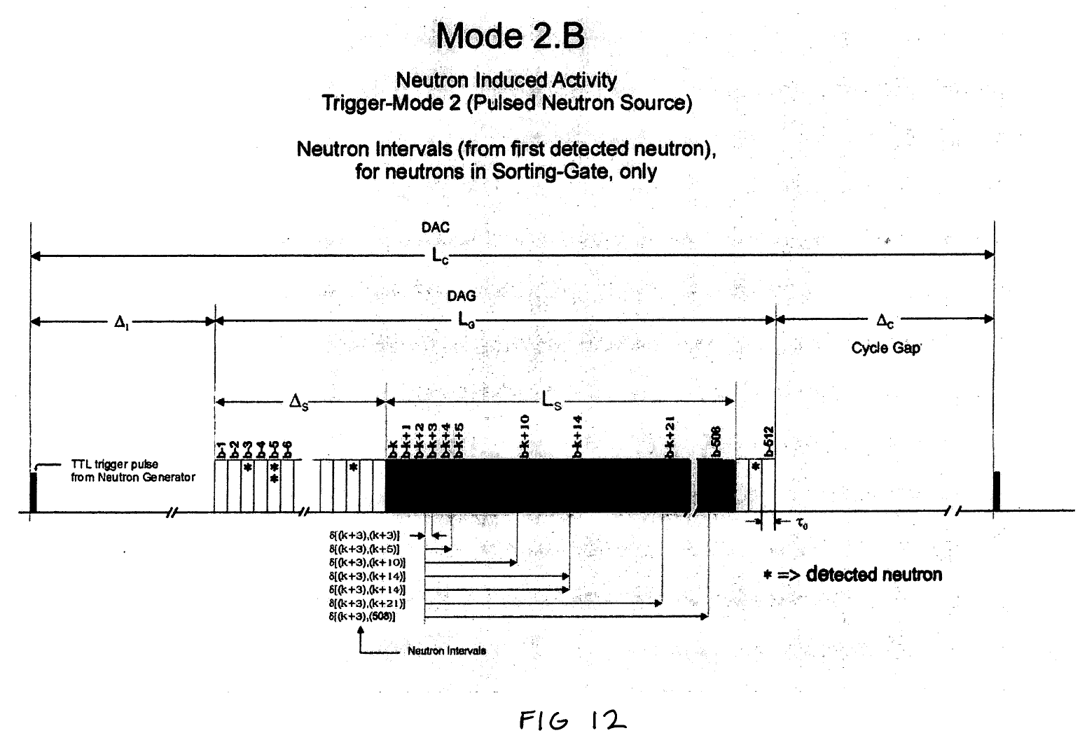

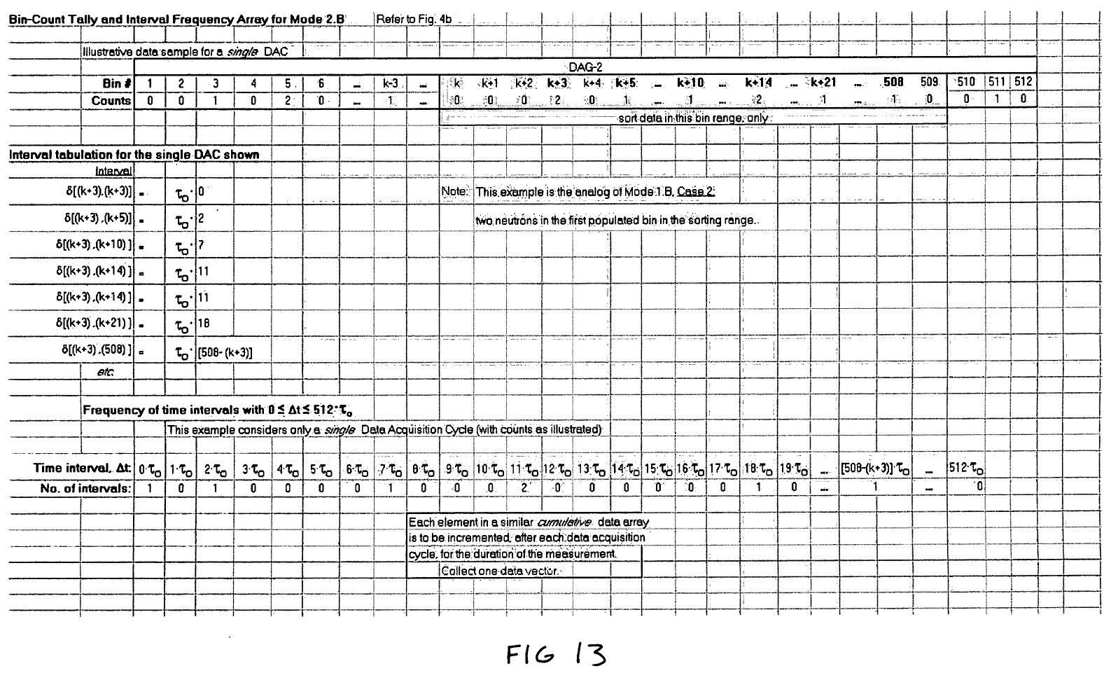

Class B: In this class of measurement data will be sorted to record statistics on the time intervals between successive neutrons detected within the DAGs. A Rossi-Alpha type of analysis can be carried out with these data. The same data sorting algorithm applies for both Mode I and Mode II. FIGS. 12 and 13 are examples of Mode 2B counting. FIGS. 6, 7, 8 and 9 are examples of Mode 1B type of counting.

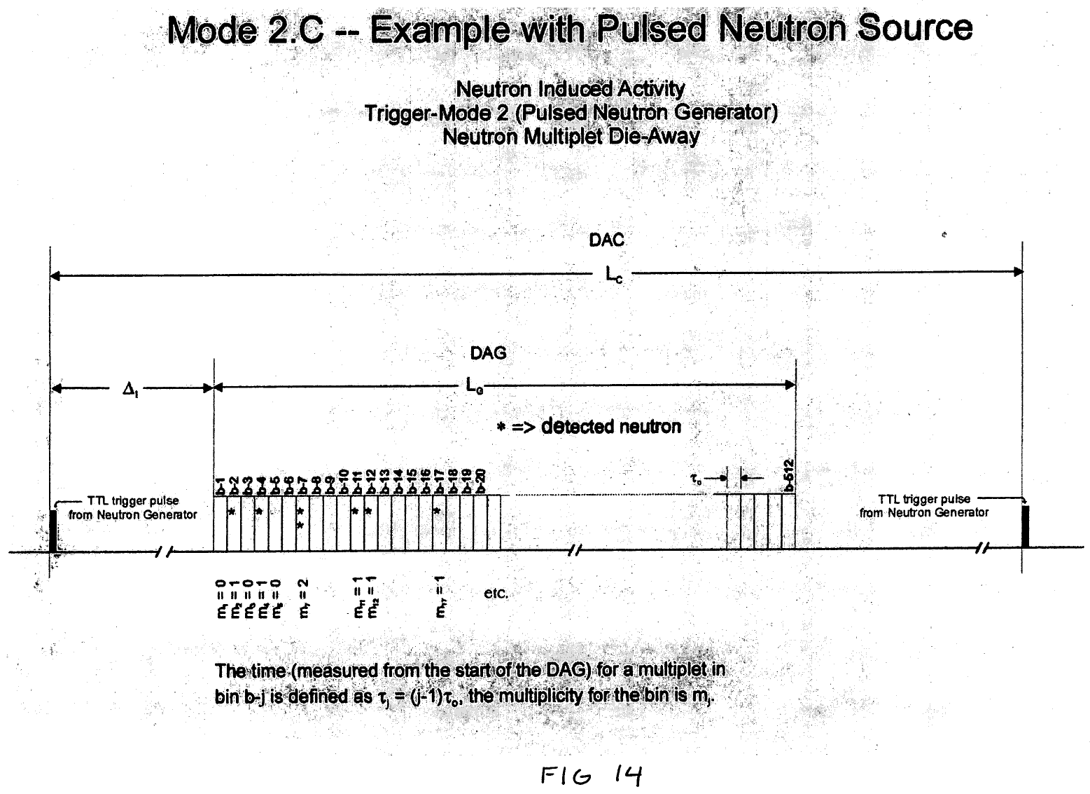

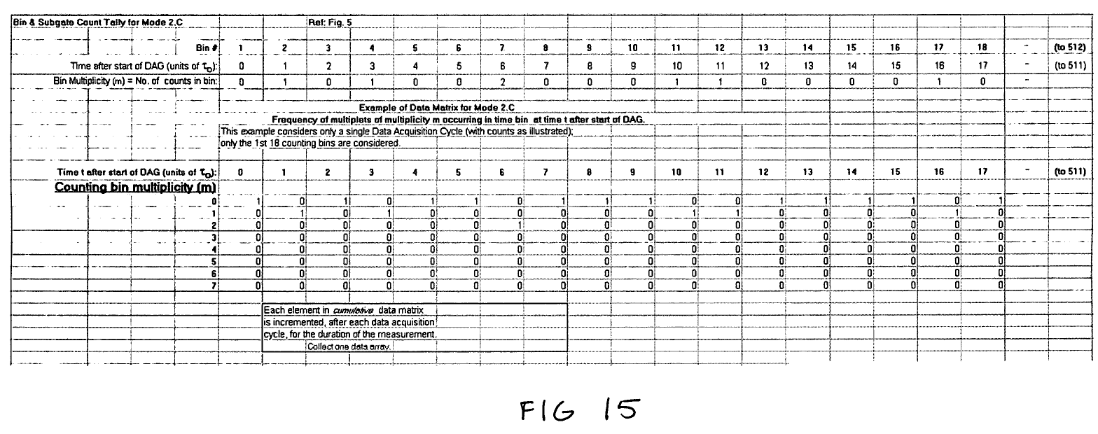

Class C: In this class of measurement data are sorted according to the number of multiplets in each time bin within the data acquisition gate. These data allow one to measure the neutron die-away following the injection of the e.g., 14-MeV neutron pulse into the sample. FIGS. 14 and 15 are examples of Mode 2C counting.

In summary, four different data sorting algorithms (depending on how you choose to categorize the counting modes) must be implemented in order to carry out all of the classes of analysis that are necessary for both Mode I and Mode II measurements, although only two are applicable in Mode I and only three are applicable in Mode II. It is desirable to implement simultaneous sorting of data by all four algorithms for all measurements, in order to simplify field operation of the detector system. Analyses will be carried out, of course, only on the data sets applicable for a particular mode.

The current neutron detectors consist of several (typically 14) ³He proportional-counter tubes embedded in a polyethylene moderator. The tubes may be in a single pod or in a pair of pods. The output pulses from the tubes are fed to an electronic module containing amplifiers and pulse-sorting circuitry.

The electronics module has four principal functions: 1) It supplies the high-voltage to the ³He tubes and power for the electronic counting circuitry from a self-contained battery pack. 2) It permits user selection of a) one of the two triggering modes, internal (Mode I) or external (Mode II), b) a “Start Delay,” Δ₁, for Mode II (set to the minimum value, 1-μs, for Mode I), c) the width, τ_{O}, of the fundamental data-sorting time bins (minimum value currently restricted to 1 μs), and d) the number of Data Acquisition Cycles (DACs) for the measurement (typically 10⁵-10⁸). 3) It amplifies and shapes the analog output signals from each tube (separate amplifier and discriminator for each tube) and feeds the signals to a data collection and sorting system. 4) It sorts the data collected on each DAC into the four data matrices required for the different modes and analysis types, and appropriately increments the cumulative data matrices at the end of each DAC. It outputs the cumulative data matrices at the end of each measurement

The electronics module will also display and/or print the average total counting rate in units of neutrons/DAG to allow the operator to adjust the length of the DAG and/or the sample-to-detector distance to achieve good data collection efficiency. It may also print a reminder to the operator that the number of neutrons/DAG needs to be large. (Since the number of counting bins will be fixed at 256, the length of the DAG is determined by the value of τ_{O} that is set).

The schematic representations of the neutron beam and the Beam Delay (Δₒ) shown in FIG. 3 apply only to Mode II, When wanting data from Mode I, the 14-MeV neutron generator (i.e., external trigger input) is not used. The start pulse for the DAC is generated internally. The delay, Δ₂ is essentially zero, and Δ₁ is kept at the minimum value consistent with the triggering and data sorting requirements for the cycle (approximately 1-μs). The user-selected value, τₒ, of the fundamental counting bin width, therefore, determines L_{G} (the number of bins is fixed at 256), and (together with the fixed value of Δ₁) the length of the DAC (L_{C}) and, of course, its inverse, the pulse repetition frequency (PRF).

In Mode II the user selects the values of τₒ, Δ₁, and the PRF of the neutron generator (within the operational limits of approximately 500-5000 Hz). The neutron generator control module provides a TTL output pulse that serves as the DAC start pulse. The neutron output from the generator occurs at a delay, Δ₀, approximately 20-40 μs after the start of the TTL pulse. The duration of the neutron beam pulse is determined by the selected PRF and the neutron generator duty factor (nominally fixed by the manufacturer at some value in the 5-10% range, but, in practice, somewhat PRF dependent). FIGS. 3, 10, 12 and 14 show timing marks.

The number of time bins in the DAG will be fixed at 256. Each bin has the same width, τₒ, which can be selected by the user to adjust the length of the DAG as required by the measurement to be made. The minimum value of τₒ is fixed at one microsecond by the current electronics in the system. The sum of neutron counts from all of the ³He tubes in the detector is recorded in each time bin. See FIGS. 2 and 3.

Δ₁ is kept to its minimum value and Δ₂ is set to zero in Mode I, in order to maximize data acquisition efficiency. In Mode II, L_{G}, Δ₁, and L_{C} can all be set by the user. If these choices are not made judiciously [i.e., if L_{C}<(L_{G}+Δ₁)], one could get a negative value of Δ₂! See FIG. 3.

In Mode II, the measurement requirements may require the neutron “beam” to be positioned entirely prior to the start of the DAG, more or less coincident with the DAG, or overlapping part of the DAG. Variability of the PRF, Δ₁, and τₒ allows such flexibility in beam position. Note that the beginning and end of the neutron “beam” is not well defined in time. Also, the term “beam” is used loosely, here; the 14-MeV neutrons are emitted isotropically by generator, and do not form a spatial beam in the usual sense of the word. See FIG. 3.

FIGS. 4 and 10 show examples of subgate detail. FIG. 12 illustrates another type of subgate counting. The Level-1 subgates shown are equivalent to the fundamental Time Bins. In principle, each Level-1 subgate could comprise 2 or more bins. If longer Level-1 subgates are required, this can be achieved, in the implementation shown, by increasing the size of τₒ. It is possible, in principle, to implement a data-sorting algorithm that contains more subgates of Level-2 and higher. There are possible modifications of the current implementation (containing the same numbers of subgates of each level) in which some of the longer subgates could comprise different groupings of time bins than the ones indicated in the figure. On any given DAC, the neutron multiplicities in some of those subgates would generally differ from the multiplicities in the illustrated set of subgates. The total multiplicity count in all subgates of a given length would, over a measurement of many DACs, be statistically equivalent for all such variations of the implementation shown.

Referring now to FIGS. 6, 8, 12 and 14: (a) The average number of neutrons per DAG needs to be large. Any data acquisition cycles on which only zero or one neutron is detected provide no useful data for the Rossi-Alpha analysis. In order to collect data efficiently, it is necessary that an average of several (say ≧10) neutrons be detected on each cycle. (b) If two neutrons are counted in a single bin, we consider the earlier of the two to be the second member of a neutron pair with the nearest preceding neutron; the later neutron is the first member of a pair with the next succeeding neutron; and the two neutrons, themselves, constitute a pair separated by a time interval smaller than τₒ. We arbitrarily define this to be a time interval of “zero” width. If three neutrons occur in a single bin, we have two intervals of zero width, etc.

The foregoing description of the invention has been presented for purposes of illustration and description and is not intended to be exhaustive or to limit the invention to the precise form disclosed. Many modifications and variations are possible in light of the above teaching. The embodiments disclosed were meant only to explain the principles of the invention and its practical application to thereby enable others skilled in the art to best use the invention in various embodiments and with various modifications suited to the particular use contemplated. The scope of the invention is to be defined by the following claims.

We claim:

1. A method of event counting, comprising:
inputing edge triggered input signals into parallel input circuits observing each event to be counted;
creating a clock to control a minimum summing interval wherein data is collected (counted), for use by a parallel set of means for adding, wherein each input circuit is operatively connected to multiple private (independent) means for adding of said parallel set;
reading a sum in each said means for adding during said minimum summing interval to produce a sum read;
zeroing each said means for adding at the end of the minimum summing interval;
storing said sum read into multiple arrays; and
constructing summed sections from said array to build data structures comprising multiple superset interval sizes, interval sizing after an external trigger, event totals in a fixed interval, event totals in a fixed interval after an external trigger, time intervals between events, time intervals between events after an external trigger, and arrival time of certain clump sizes after an external trigger.

2. A method of event counting, comprising:
inputing input signals into parallel input circuits observing each event to be counted;
controlling a minimum summing interval in which data is counted for use by a parallel set of means for adding;
producing a sum read;
zeroing each said means for adding;
storing said sum read; and
building data structures.

3. The method of claim 2, wherein said input signals are edge triggered.

4. The method of claim 2, wherein said minimum summing interval is controlled with a clock.

5. The method of claim 2, wherein each input circuit is operatively connected to multiple independent means for adding of said parallel set.

6. The method of claim 2, wherein said sum read is produced by reading a sum in each said means for adding during said minimum summing interval.

7. The method of claim 2, wherein said means for adding are zeroed at the end of a minimum summing interval.

8. The method of claim 2, wherein said sum read is stored into multiple arrays.

9. The method of claim 2, wherein said data structures are built by constructing summed sections from said array

10. The method of claim 2, wherein said data structures comprise data selected from the group consisting of multiple superset interval sizes, interval sizing after an external trigger, event totals in a fixed interval, event totals in a fixed interval after an external trigger, time intervals between events, time intervals between events after an external trigger, and arrival time of certain clump sizes after an external trigger.

11. The method of claim 2, wherein said data structures comprise multiple superset interval sizes, interval sizing after an external trigger, event totals in a fixed interval, event totals in a fixed interval after an external trigger, time intervals between events, time intervals between events after an external trigger, and arrival time of certain clump sizes after an external trigger.

12. An apparatus for event counting, comprising:
means for inputing input signals into parallel input circuits observing each event to be counted;
means for controlling a minimum summing interval in which data is counted for use by a parallel set of means for adding;
means for producing a sum read;
means for zeroing each said means for adding;
means for storing said sum read; and
means for building data structures.
